(19) United States
(12) Patent Application Publication
(10) Pub. No.: US 2022/0314605 A1
(43) Pub. Date: Oct. 6, 2022

(54) PRINTER FOR PRINTING HISTOLOGY LABORATORY CONSUMABLE ARTICLES

(71) Applicant: LEICA BIOSYSTEMS NUSSLOCH GMBH, Nussloch (DE)

(72) Inventor: Karl-Heinz WESTERHOFF, Eppingen (DE)

(21) Appl. No.: 17/627,219

(22) PCT Filed: Jul. 6, 2020
(86) PCT No.: PCT/EP2020/068974

§ 371 Date: Jan. 14, 2022

(30) Foreign Application Priority Data
Jul. 18, 2019 (DE) 10 2019 119 500.4

(51) Int. Cl. B41J 2/045

(52) U.S. Cl. CPC B41J 2/04541; B41J 2/04586

(57) ABSTRACT

A printer for printing on unused histology-laboratory consumable articles including an optical reading apparatus which reads an image pattern of a histology-laboratory consumable article to be printed on, generates analog or digital image signals relating to the image pattern that has been read, and transfers the image signals to a control apparatus of the printer which evaluates the received image signals and as a function of the evaluation result establishes at least one processing step for the further processing of the histology-laboratory consumable article with regard to the quality of the impression to be printed.

### CROSS-REFERENCE TO RELATED APPLICATIONS

The present application is the U.S. national phase of International Application No. PCT/EP2020/068974 filed Jul. 6, 2020, which claims priority to German Application No. 10 2019 119 500.4 filed Jul. 18, 2019, the entire disclosures of which are incorporated herein by reference.

### FIELD OF THE DISCLOSURE

The invention relates to a printer for printing on unused histology-laboratory consumable articles.

### BACKGROUND OF THE DISCLOSURE

Histological samples taken from a patient pass through a multiplicity of treatment steps in various treatment stations in a histological laboratory before they can be examined, for example with a microscope.

During the preparation of histological samples within the scope of an embedding process for a subsequent microtomy, the samples are initially fixated by the application of a fixative, for example formalin. Subsequently, any tissue fluid present is removed from the sample. This is implemented in several steps by way of the treatment with alcohol with increasing purity. In order to transfer the samples treated thus into a state permitting cutting by means of a microtome, an embedding medium—for example paraffin, gelatin, agar, nitrocellulose, polyester wax, polyethylene glycol or plastic—is infiltrated into the samples. During the aforementioned processes, the samples are usually in a cassette which has a multiplicity of sieve-like openings in order to be able to rinse the samples with the chemicals. A special embodiment of such a cassette is known from DE 43 33 118 A1, for example.

After infiltrating the embedding medium, the samples can be taken from the cassette and can be blocked in paraffin. Subsequently, the block can be cut into thin sections using a microtome, which are individually placed on slides. Subsequently, the thin sections can be stained for the microscopic examination.

In the process sequence, it is necessary in particular to ensure that the samples can at all times be assigned to the patient. To this end, special printers with which the cassettes in which the samples are intended to be fitted, and/or the slides can be printed on in particular with patient-relevant data or data which can be assigned to the patient are used in histological laboratories. In this case, it is very important for the impression to be readable sufficiently accurately and sufficiently durably.

EP 1 245 395 A2 describes a method and an apparatus for printing on plastic cassettes for histological preparations and/or slides for microscopic thin sections. The apparatus comprises a computer device for controlling the printing device. The printing device contains an inkjet printer for printing on the cassettes and/or the slides. The ink is predried by means of a warm-air dryer and fully dried by means of a flash device.

US 2019/0324048 A1 discloses a slide printer which prints two barcodes onto a slide. A first barcode relates to a control tissue sample while a second barcode relates to a patient tissue sample. The slide printer contains a barcode reader which can read the first barcode printed previously by the slide printer itself

### SUMMARY OF THE DISCLOSURE

The object of the present invention is to provide a printer for printing on histology-laboratory consumable articles, which offers the possibility of improving the quality of the impression, in particular with regard to printing accuracy, sharpness and/or durability.

The object is achieved by a printer for printing on histology-laboratory consumable articles, which is characterized by an optical reading apparatus which reads an image pattern of a histology-laboratory consumable article to be printed on, generates analog or digital image signals relating to the image pattern that has been read, and transfers the image signals to a control apparatus of the printer which evaluates the received image signals and as a function of the evaluation result establishes at least one processing step for the further processing of the histology-laboratory consumable article with regard to the quality of the impression to be printed.

According to the invention, it has been discovered that different cassettes, for example cassettes from different manufacturers, or cassettes which have been produced by different production processes, have very different properties in relation to the precise applicability and durability of an impression. In particular, it may for example be the case that the cassettes of a first manufacturer can be printed on particularly well and durably with a particular ink under certain printing parameters, while printing on cassettes from a different manufacturer under the same printing parameters and with the same ink leads to deficient results. In particular, it may for example disadvantageously happen that the impression is out of focus, blurring occurs or the impression is not sufficiently durable if a cassette insufficiently suitable for the adjusted printing parameters and/or the ink used is printed on. This may, for example, be attributable to the fact that the cassettes from different manufacturers or different product series are produced from different materials or material mixtures, in particular from different plastics.

In this case, a very particular difficulty is that the user cannot in general see directly from the cassettes used whether a sufficiently high-quality impression is possible with the printer used by them or the ink used by them. In particular, it may disadvantageously happen that insufficiently high-quality impressions are produced in large runs without the laboratory staff immediately noticing the deficiency of the impressions.

The same applies similarly when printing on other types of histology-laboratory consumable articles, for example slides, is involved.

The printer according to the invention has the very particular advantage that by means of the optical reading apparatus it is possible to establish beforehand whether the histology-laboratory consumable article to respectively be printed on can be printed on with sufficient quality. To this end, by means of the optical reading apparatus, the printer reads an image pattern, which may for example be or contain a manufacturer logo or product logo, from the histology-laboratory consumable article respectively to be printed on and transfers corresponding analog or digital image-pattern image signals relating to the image pattern that has been read to a control apparatus. If, after an evaluation of the received image signals, the control apparatus establishes for example that the histology-laboratory consumable article is to be assigned to a particular manufacturer and/or a particular product series, in the next step it may establish whether and/or with which printing parameters an impression should be carried out. For this, it is advantageous for the relevant data relating to the histology-laboratory consumable articles of different manufacturers or different product series to be saved in a memory of the control apparatus.

It is in particular also possible for the control apparatus to establish that a histology-laboratory consumable article from which an image pattern has just been read cannot be printed on with sufficient quality; this, for example, because a histology-laboratory consumable article which is not compatible with the adjusted printing parameters and/or the ink used is being used. In this case, for example, the impression may be rejected or alternatively a warning may be output to the laboratory staff. In such a case, it may alternatively also be provided that an impression is carried out only after outputting a warning and after confirmation by the laboratory staff that printing is still desired. Correspondingly, as a precaution it is also possible to proceed in this way when a histology-laboratory consumable article to be printed on does not have an image pattern detectable by the optical reading apparatus or when a detected image pattern cannot be assigned to any manufacturer and/or any product series.

According to the invention, the control apparatus evaluates the received image signals and, as a function of the evaluation result, establishes at least one processing step for the further processing of the histology-laboratory consumable article. However, this establishment of a processing step or of a plurality of processing steps is not necessarily final. For example, the control apparatus may initially establish as a processing step that an input by the user is required. The control apparatus may then establish further processing steps after the input is received and depending on the decision by the user.

The request for an input from a user may in particular be carried out when a histology-laboratory consumable article to be printed on, which is not compatible with the printing parameters of the printer, has been put into the printer, or when a histology-laboratory consumable article to be printed on does not have an image pattern that can be detected by the optical reading apparatus, or when a detected image pattern cannot be assigned to a manufacturer and/or a product series during the evaluation. The current printing parameters of the printer may, for example, relate to the ink or the toner or a drying temperature or a drying duration or a font size to be used or a font type to be used.

The printer may comprise a button or a keypad and/or another input apparatus, by means of which the user can make an input. As an alternative or in addition, it is also possible for the input to be entered via a computer, to which the printer is connected directly or via a network. The control apparatus evaluates the input and, as a function of the content of the input, may then delete an already established processing step and/or establish at least one further processing step for the further processing of the histology-laboratory consumable article.

For example, the control apparatus may delete the originally intended processing step of applying an impression when the user has input that printing on the histology-laboratory consumable article, in relation to which an input has been requested, should not take place.

In one very particularly advantageous embodiment, the control apparatus may stop the further processing of a histology-laboratory consumable article, in relation to which an input is expected, until the input arrives, and instead begin or continue the processing of at least one other histology-laboratory consumable article. This embodiment has the very particular advantage that the time available for printing on a multiplicity of histology-laboratory consumable articles is constantly utilized. In particular, it can advantageously be provided that a histology-laboratory consumable article for which an input is expected may temporarily be excluded and transferred to a standby position. As soon as the required input has taken place, the histology-laboratory consumable article is retrieved from the standby position and then, particularly as a function of the input made, either processed further and provided with a predetermined or individually predeterminable impression, or discarded without applying an impression.

It is possible for one of the processing steps to involve outputting a message to a user. For example, the printer according to the invention may be adapted in such a way that the control apparatus outputs the message that everything is in order and an impression as intended can be carried out when the control apparatus has recognized the histology-laboratory consumable article to be printed on and has established that a high-quality impression is possible. Similarly, it is also possible for a warning to be output when the control apparatus has recognized that a sufficiently high-quality impression is not possible or when the control apparatus has not been able to assign a manufacturer and/or a product series to the detected image pattern during the evaluation.

In particular, a processing step established by the control apparatus may involve printing on the histology-laboratory consumable article, the image pattern of which has been read and evaluated, with a predetermined or individually predeterminable impression. For example, the control apparatus establishes this step when it has been able to assign the image pattern read from the histology-laboratory consumable article to a particular manufacturer and/or a particular product series, of which the control apparatus has the information that printing with the adjusted printing parameters is possible with a sufficiently high quality.

In particular, for this purpose assignment of different image patterns to the information as to whether or not a sufficiently high-quality impression is possible may be saved in a memory device of the control apparatus.

As an alternative or in addition, the assignment which is saved in a memory device of the control apparatus may also contain more detailed information, for example information about required printing parameters. The required printing parameters may for example relate to properties of the ink advantageously to be used or a drying temperature or a drying duration or information about a duration and/or temperature of warm-air predrying or about a temperature and duration of full drying in a flash device or about a font size to be used or a font type to be used.

In one particularly flexibly usable embodiment of the printer according to the invention, the control apparatus matches at least one printing parameter of the printer individually to the printing parameters determined as being required.

In particular, the printer may advantageously examine each histology-laboratory consumable article for image patterns by means of the optical reading apparatus, and in the event that an impression should be carried out, provide them with a predetermined or individually respectively predeterminable impression. For example, the printer may advantageously receive the information about the impression individually to be applied, which may in particular contain patient data, from a superordinate computer to which the printer is connected directly or via a network.

As already mentioned, it may also happen that one of the processing steps established by the control apparatus involves discarding the histology-laboratory consumable article without printing on it. This may in particular be done in combination with the output of a warning to the user, for example on a display of the printer, and/or on a connected computer.

In one particularly advantageous embodiment, the control apparatus keeps a log. In particular, whether it has been possible to read an image pattern and/or whether it has been possible to evaluate an image pattern that has been read and/or whether it has been possible to assign an image pattern that has been read to a manufacturer or a product series and/or whether an impression has been carried out, may advantageously be logged for each individual histology-laboratory consumable article introduced. The log may in particular contain the image pattern per se and/or data relating to the impression carried out. Furthermore, the log may contain information about the instant of the processing of the respective histology-laboratory consumable article and/or about an assigned patient and/or the batch number of the printing medium used and/or the batch number of the histology-laboratory consumable article used.

Preferably, the control apparatus saves the log data continuously in a memory and/or outputs the log data via an interface. As an alternative or in addition, it is also possible for the control apparatus to display, in particular continuously display, the log data on an output apparatus, for example a display of the printer.

In one very particularly advantageous embodiment, the log data are transferred to a superordinate computer and saved and/or processed further there.

In particular—and according to an independent inventive concept—the superordinate computer may advantageously receive further log data of other printers and/or other laboratory equipment and save and/or further process them, in particular together with the log data of the printer. Very generally and according to the independent inventive concept, a histology laboratory system which contains a superordinate computer that receives, saves and/or further processes the log data of a printer according to the invention and/or further log data of other laboratory equipment is particularly advantageous.

Preferably, the log data and the further log data, which relate to the same sample, are saved and/or processed further by the superordinate computer while being assigned to one another and together. In particular, this makes it possible for a superordinate log, which contains the log data transferred from the printer and the further log data of other printers and/or other laboratory equipment, to be compiled by the superordinate computer in particular in a sample-specific manner. The superordinate log may preferably contain data relating to all process steps during the processing of a sample in a histological laboratory. To this extent, the superordinate log may in particular contain log data and further log data, which contain the processing of a sample from the cutting station to the diagnosis by means of a microscope. It is, however, also possible for the superordinate log to contain log data and further log data of a subsection of such a processing sequence of a sample.

In one variant, logging is exclusively carried out only in the cases recognized as problematic, for example because it has not been possible to read an image pattern or because it has been found after the evaluation that it has not been possible to carry out an impression with a sufficiently high quality.

In particular, one of the processing steps may involve saving the image signals of the image pattern that has been read and/or saving information determined by the control apparatus about the histology-laboratory consumable article. This may in particular be carried out in such a way that the corresponding data are stored in the log already mentioned above.

In one particularly advantageous embodiment, the control apparatus compares the image signals received from the optical reading apparatus with the image signals of at least one reference image pattern. To this end, a memory apparatus in which image signals of at least one reference image pattern are saved or can be saved may be provided. The control apparatus may individually call up the reference image patterns from the memory apparatus and compare them with the image signals received from the optical reading apparatus.

As already mentioned, the control apparatus may advantageously determine on the basis of the image signals whether, and optionally how, in particular with which printing parameters, the respective histology-laboratory consumable article is to be printed on.

In one particularly flexible embodiment, the control apparatus determines on the basis of the image signals where a printing field is located on the histology-laboratory consumable article. If it is established that an impression should be carried out, the control apparatus causes the printing to be carried out exactly in the printing field. In such an embodiment of the printer according to the invention, very different histology-laboratory consumable articles may be used particularly flexibly.

The optical reading apparatus may in particular be configured and arranged to read an image pattern configured as a barcode or as a QR code or as a logo or as text. There are no fundamental restrictions in relation to the type of image patterns that can be read. In particular, the image pattern can also be a purely analog image pattern, in particular an image pattern containing no binary symbols (in particular no standardized bars and/or dots and no standardized gaps therebetween). In this respect, the image pattern can also be designed in such a way that it contains no barcode and no matrix code (e.g., QR code) or the like.

In one very particularly advantageous embodiment, it is in particular not necessary for the image patterns always to be arranged at the same location on the histology-laboratory consumable article. Rather, in this embodiment the entire histology-laboratory consumable article is detected by means of the optical reading apparatus in order to establish where an image pattern that can be evaluated is located.

Preferably, the printer according to the invention comprises a compartment for a multiplicity of histology-laboratory consumable articles to be printed on, from which the transport apparatus individually takes the histology-laboratory consumable articles to be printed on and transports them further. In this case, the optical reading apparatus may in particular advantageously read the image pattern respectively during the transport. This has the particular advantage that the reading of the impression may be carried out in dead time so that the overall process sequence inside the printer is not slowed down.

As already mentioned, the histology-laboratory consumable article may for example be a cassette for tissue samples or a slide, in particular for thin sections. To this extent, the printer may be specially configured as a cassette printer and/or as a slide printer.

The printer according to the invention may, in particular, be configured as an inkjet printer or as a laser printer.

### BRIEF DESCRIPTION OF THE DRAWING VIEWS

The subject-matter of the invention is represented by way of example and schematically in the drawing and will be described below with the aid of the figures, elements which are the same or have the same effect also usually being provided with the same references in the various exemplary embodiments.

FIG. 1 shows an exemplary embodiment of a printer according to the invention,

FIG. 2 shows a second exemplary embodiment of a printer according to the invention,

FIG. 3 shows a detail of a third exemplary embodiment of a printer according to the invention, and

FIG. 4 shows a detail of a fourth exemplary embodiment of a printer according to the invention.

### DETAILED DESCRIPTION

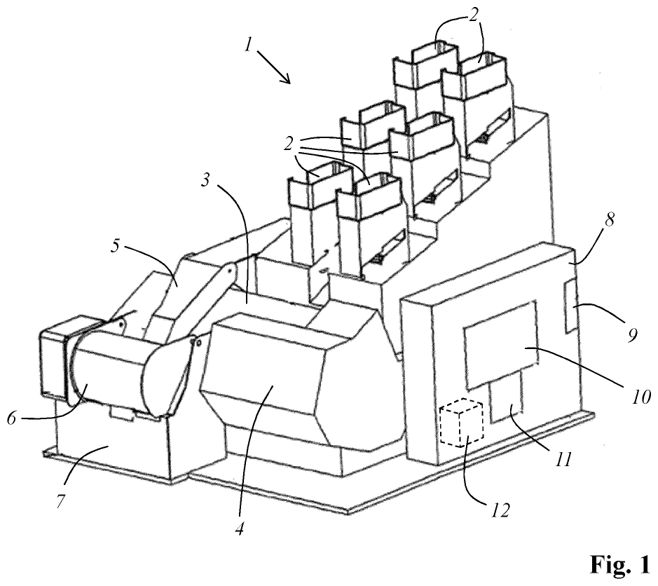

FIG. 1 shows an exemplary embodiment of a printer according to the invention, which comprises a material supply 1. The material supply 1 contains a plurality of stack magazines 2 for histology-laboratory consumable articles 16 (not visible in this figure) to be printed on, for example cassettes 17 or slides 19. The material supply 1 is assigned a transport apparatus 3 which respectively transports a histology-laboratory consumable article 16 in succession from the material supply 1 to a printing device 4. The printing device 4 may, for example, contain an inkjet printer. The histology-laboratory consumable articles 16 that have been printed on are conveyed by the transport apparatus 3 to a warm-air drying apparatus 5 and predried there. The histology-laboratory consumable articles 16 are then conveyed to a flash device 6 which ensures full drying of the ink by supplying heat with infrared radiation and/or UV radiation. The histology-laboratory consumable articles 16 processed in this way are subsequently forwarded to a removal device 7.

The printer comprises an optical reading apparatus 13 (not visible in FIG. 1), which reads an image pattern 18 (not visible in FIG. 1) of a histology-laboratory consumable article 16 to be printed on and generates analog or digital image signals relating to the image pattern 18 that has been read. The image signals are transferred to a control apparatus 8 of the printer. The control apparatus 8 comprises an interface 9 for connecting the printer to a computer network or for direct connection to a computer.

The control apparatus 8 furthermore comprises a display 10, by means of which messages can be output to a user. In particular, the display 10 may also be used to request inputs by a user, which the user may input via an input apparatus 11, which may for example be a keypad. The display 10 may, for example, also be used to continuously display information about the image patterns 18 that have been recognized by means of the optical reading apparatus and/or the evaluation results relating to the image patterns that have been read.

The control apparatus 8 contains a memory apparatus 12 in which image signals of reference image patterns can be saved and/or in which information relating to the image patterns that have been read optically and/or the evaluation results and/or relating to the impression and/or the data relating to the image patterns that have been read in each case and/or relating to the processing steps carried out or to be carried out can be saved. In particular, a log, which may be forwarded via the interface 9 to a connected computer and/or which may be represented on the display 10, may advantageously be saved in the memory apparatus 12.

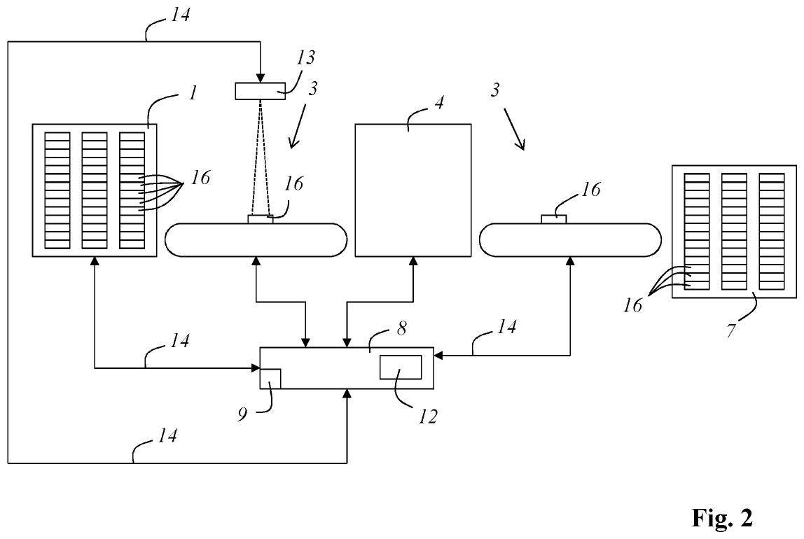

FIG. 2 schematically shows a second exemplary embodiment of a printer according to the invention.

The printer comprises a material supply 1, in which histology-laboratory consumable articles 16 to be printed on, for example cassettes 17 or slides 19, can be stored.

The printer furthermore comprises a transport apparatus 3, which respectively transports a histology-laboratory consumable article 16 in succession from the material supply 1 to a printing device 4. The transport apparatus 3 furthermore transports the histology-laboratory consumable articles 16 that have been printed on by the printing device 4 to a removal device 7, from which the histology-laboratory consumable articles 16 that have been printed on can then be removed.

The printer furthermore comprises an optical reading apparatus 13, which reads an image pattern 18 of a histology-laboratory consumable article 16 to be printed on, generates analog or digital image signals relating to the image pattern 18 that has been read and transfers the image signals to a control apparatus 8 of the printer.

The control apparatus 8 comprises an interface 9 for connecting the printer to a computer network, a superordinate computer or for direct connection to a computer.

The control apparatus 8 is connected by means of data cables 14 to the optical reading apparatus 13, to the material supply 1, the transport apparatus 3 and the printing device 4, in order to receive data and/or output control instructions.

The control apparatus 8 evaluates the image-pattern image signals received from the optical reading apparatus 13 and establishes at least one processing step for the further processing of the histology-laboratory consumable articles 16 as a function of the evaluation result. During the evaluation, the control apparatus 8 compares the image signals received from the optical reading device 13 with the image signals of at least one reference image pattern.

If the control apparatus 8 has recognized the histology-laboratory consumable article 16 to be printed on and has established that a high-quality impression is possible, the control apparatus 8 outputs the message that everything is in order. At the same time, the control apparatus 8 establishes as a further processing step that an impression as intended should be carried out.

If the evaluation reveals that a sufficiently high-quality impression is not possible, or if the control apparatus 8 has not been able to assign a manufacturer and/or a product series to the detected image pattern 18 during the evaluation, a warning is output. In particular, in this case an impression may not be carried out until after confirmation by the laboratory staff that printing is still desired.

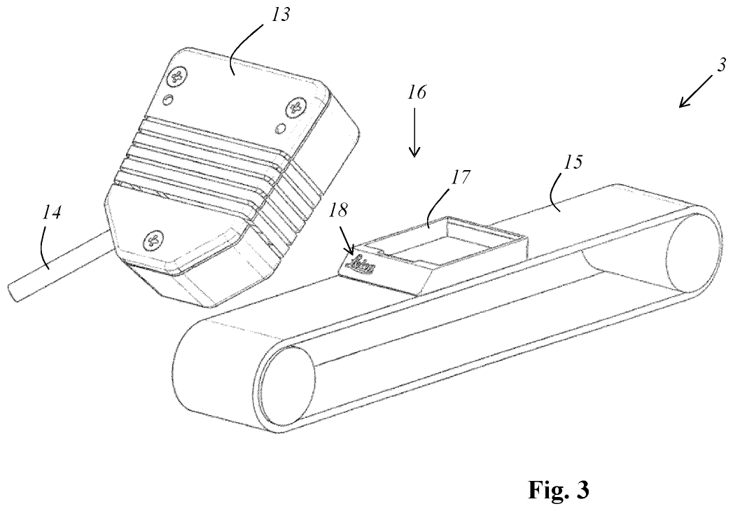

FIG. 3 shows a detail of a third exemplary embodiment of a printer according to the invention, which transports further a transport device 3 for transporting histology-laboratory consumable articles 16 coming from a material supply 1 (not represented in this figure).

The printer contains an optical reading apparatus 13, which may for example be configured as a digital camera. The optical reading apparatus 13 is connected via a data cable 14 to a control apparatus 8 (not represented in this figure). The optical reading apparatus 13 forwards analog or digital image signals relating to the image pattern 18 that has respectively been read via the data cable 14 to the control apparatus 8.

The transport device 3 comprises a conveyor belt 15 on which histology-laboratory consumable articles 16, namely cassettes 17, are transported. The optical reading apparatus 13 reads an image pattern 18 of each histology-laboratory consumable article 16 passing it and forwards image signals relating to the image pattern 18 that has been read to the control apparatus 8 (not represented in this figure).

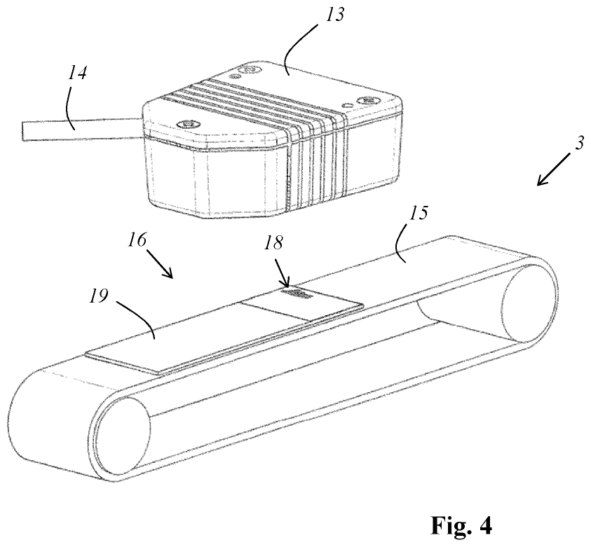

FIG. 4 shows a detail of a fourth exemplary embodiment of a printer according to the invention, which transports further a transport device 3 for transporting histology-laboratory consumable articles 16 coming from a material supply 1 (not represented in this figure).

The printer contains an optical reading apparatus 13, which may for example be configured as a digital camera. The optical reading apparatus 13 is connected via a data cable 14 to a control apparatus 8 (not represented in this figure). The optical reading apparatus 13 forwards analog or digital image signals relating to the image pattern 18 that has respectively been read via the data cable 14 to the control apparatus 8.

The transport device 3 comprises a conveyor belt 15 on which histology-laboratory consumable articles 16, namely slides 19, are transported. The optical reading apparatus 13 reads an image pattern 18 of each histology-laboratory consumable article 16 passing it and forwards image signals relating to the image pattern 18 that has been read to the control apparatus 8 (not represented in this figure).

### LIST OF REFERENCES

1 material supply

2 stack magazine

3 transport apparatus

4 printing device

5 warm-air drying apparatus

6 flash device

7 removal device

8 control apparatus

9 interface

10 display

11 input apparatus

12 memory apparatus

13 optical reading apparatus

14 data cable

15 conveyor belt

16 histology-laboratory consumable article

17 cassette

18 image pattern

19 slide

1. A printer for printing on unused histology-laboratory consumable articles (16), comprising an optical reading apparatus (13) which reads an image pattern of the histology-laboratory consumable article (16) to be printed on, generates analog or digital image signals relating to the image pattern (18) that has been read, and transfers the image signals to a control apparatus (8) of the printer which evaluates the received image signals and as a function of the evaluation result establishes at least one processing step for the further processing of the histology-laboratory consumable article (16) with regard to the quality of the impression to be printed.

2. The printer as claimed in claim 1, wherein an assignment of different image patterns to the information as to whether or not a sufficiently high-quality impression is possible is saved in a memory device of the control apparatus.

3. The printer as claimed in claim 1, wherein one of the processing steps involves requesting an input by a user.

4. The printer as claimed in claim 3, wherein the control apparatus (8) evaluates the input, and as a function of the input, deletes an already established processing step and/or establishes at least one further processing step for the further processing of the histology-laboratory consumable article (16).

5. The printer as claimed in claim 3, wherein the control apparatus (8) stops the processing of a histology-laboratory consumable article (16), in relation to which an input is expected, until the input arrives, and instead begins or continues the processing of at least one other histology-laboratory consumable article (16).

6. The printer as claimed in claim 1, wherein one of the processing steps involves outputting a message to a user.

7. The printer as claimed in claim 1, wherein one of the processing steps involves printing on the histology-laboratory consumable article (16).

8. The printer as claimed in claim 1, wherein one of the processing steps involves discarding the histology-laboratory consumable article (16) without printing on it.

9. The printer as claimed in claim 1, wherein one of the processing steps involves saving the image signals of the image pattern (18) that has been read and/or saving information determined by the control apparatus (8) about the histology-laboratory consumable article (16).

10. The printer as claimed in claim 1, wherein, in order to evaluate the received image signals, the control apparatus (8) compares the image signals received from the optical reading apparatus (13) with the image signals of at least one reference image pattern.

11. The printer as claimed in claim 10, wherein a memory apparatus in which image signals of at least one reference image pattern are saved or can be saved is provided.

12. The printer as claimed in claim 1, wherein the control apparatus (8) determines where a printing field is located on the histology-laboratory consumable article (16) on the basis of the image signals.

13. The printer as claimed in claim 1, wherein the control apparatus (8) establishes at least one printing parameter to be adjusted as a function of the image signals of the image pattern (18) that has been read.

14. The printer as claimed in claim 1, wherein the optical reading apparatus (13) is configured and arranged to read an image pattern (18) configured as a barcode or as a QR code or as a logo or as text.

15. The printer as claimed in claim 1, wherein the printer comprises a compartment for a multiplicity of histology-laboratory consumable articles (16) to be printed on, from which a transport apparatus individually takes the histology-laboratory consumable articles (16) to be printed on and transports them further and in that the optical reading apparatus (13) reads the image pattern (18) respectively during the transport of a histology-laboratory consumable article (16) to be printed on.

16. The printer as claimed in claim 1, wherein the control apparatus (8) continuously keeps a log.

17. The printer as claimed in claim 16, wherein the control apparatus (8) saves log data in a memory and/or outputs them via an interface and/or displays them on an output device.

18. The printer as claimed in claim 1, wherein the printer is configured as an inkjet printer or as a laser printer.

19. The printer as claimed in claim 1, wherein the printer is configured as a cassette printer and/or as a slide printer and/or as a label printer.

20. The printer as claimed in claim 1, wherein the histology-laboratory consumable article (16) is a cassette or a slide.

21. A histology laboratory system which comprises a printer as claimed in claim 1 and a superordinate computer, which receives log data from the printer.

22. The histology laboratory system as claimed in claim 21, wherein:
a. the superordinate computer receives further log data of other printers and/or other laboratory equipment, or
b. the superordinate computer receives further log data of other printers and/or other laboratory equipment and respectively saves and/or further processes the log data and the further log data, which relate to the same sample, while being assigned to one another and together.
